(19) United States
(12) Patent Application Publication
(10) Pub. No.: US 2011/0307918 A1
(43) Pub. Date: Dec. 15, 2011

(54) METHOD AND APPARATUS FOR INTERACTIVE MOBILE COUPON/OFFER DELIVERY STORAGE AND REDEMPTION SYSTEM USING A RECEIVING DEVICE AND A SECOND INTERACTIVE DEVICE

(76) Inventor: Brian Shuster, Los Angeles, CA (US)

(21) Appl. No.: 13/158,358

(22) Filed: Jun. 10, 2011

Related U.S. Application Data
(60) Provisional application No. 61/354,071, filed on Jun. 11, 2010.
(60) Provisional application No. 61/354,079, filed on Jun. 11, 2010.
(60) Provisional application No. 61/354,082, filed on Jun. 11, 2010.
(60) Provisional application No. 61/354,086, filed on Jun. 11, 2010.

(51) Int. Cl. H04N 7/16; G06Q 30/00; H04N 9/80

(52) U.S. Cl. 725/23; 386/241; 705/14.39; 386/E09.011

(57) ABSTRACT

A method for providing real-time interaction with broadcasted audio/video content is disclosed. The method involves sampling an audio segment from a broadcasted audio/video content, converting the sampled audio segment to a digital signal, comparing the digital signal with a digital snapshot of an audio pattern that corresponds to the audio portion of the broadcasted audio/video content, determining a current position relative to a beginning of the broadcasted audio/video content based on the comparing, displaying on a second audio/video device an interactive display based on the determined current position. In alternate embodiments, the method provides an interactive coupon/offer delivery via a mobile device, a method for bookmarking a point within a video stream, and a method for retrieving a stored video stream.

This is a non-provisional application claiming the benefit of U.S. Provisional Application No. 61/354,071 giled Jun. 11, 2010. U.S. Provisional Application No. 61/354,079 filed Jun. 11, 2010. U.S. Provisional Application No. 61/354,082 filed Jun. 11, 2010, and U.S. Provisional Application No. 61/354,086 filed Jun. 11, 2010.

### BACKGROUND OF THE INVENTION

This invention relates to the creation of a relationship between consumers/viewers with a mobile CPU (Mobile device such as a phone, a pad, a laptop, or other similar devices) and a video screen, a digital screen, a kiosk, a billboard and any related signage, whether digital or not. More particularly, the present invention provides an eco-system and method for consumers and/or viewers with a mobile CPU (Mobile device such as a phone, a pad, a laptop, or other similar devices) to engage with “meta data” (such as but not limited to coupons, special offers, discounts, games, quizzes, trivia, polls, social integration) related to content from a video screen, a digital screen, a kiosk, a billboard and any related signage, whether digital or not.

This invention enables consumers/viewers to receive “meta data” information, via a Mobile device such as a phone, a pad, a laptop, or other similar devices) that is synchronized and/or sequenced related to the content, events or message of a video, and/or related to content from a video screen, a digital screen, a kiosk, a billboard and any related signage, whether digital or not. Additionally this invention enables location-based services to add value to both the consumers/viewers and the entertainment and marketing world, so that the consumers can not only interact with the content, from a video screen, a digital screen, a kiosk, a billboard and any related signage, but also provides supplemental “meta data” related to their location, again making that meta data even more relevant to the consumer and more valuable to the content creators the advertisers and worldwide marketers.

In the entertainment and marketing world, the object and goal of those businesses is to reach as many consumers as possible. They reach those consumers through many different mediums. The majority of those communications/messages are delivered to the consumer/audience via a “one way” message delivery system. This invention provides an eco-system for the entertainment and marketing world to now deliver those communications and messages and allowing the consumer/viewer to interact and participate in real time, creating a bi-directional communication with the entertainment and marketing world. Not only does this invention enable them to interact with the content in real time, it also enables the consumer/viewer the ability to electronically share the complete experience and “meta data” within socially networked environments, that include Facebook, Twitter and others. This audience effects the worldwide population who own a mobile CPU.

Today large audiences regularly watch television and DVR content from a video screen. They are also exposed to content via other screens, such as a kiosk, a billboard and any related signage, either video or static. Advertisers, Broadcasters, marketers and content creators (film and video) are constantly looking for ways to enhance the viewing experience of their programs and add value with interactive “meta data” related to the content. Presently, there are several other methods that enable the consumer to interact with video programming and signage but they have significant shortcomings. These systems provide the consumer additional information related to the video or signage, and in order to attain additional information the consumer needs to either send text message to request information, download applications that provide certain functions, emailing, but these systems fail to provide interactive “meta data” synchronized and/or sequenced with the content that live in an eco-system on the mobile device.

To fully enhance and integrate the user experience and add value to the consumer, the entertainment provider and the worldwide marketing/advertising sectors can now provide, with this invention the delivery of the intended interactive “meta data” discussed above. The invention enables the “meta data” to be synchronized and sequenced to the viewer and consumer at the proper times to correspond with the location and the action and/or content data related to content from/on a video screen, a digital screen, a kiosk, a billboard and any related signage, whether digital or not.

Furthermore, current mobile phones and a variety mobile handheld technologies provide limited advertising functionality such as banner ads, SMS requests that may take a user to a specific site to view advertisements, promotions, daily offers, etc. However, overall usage has been limited to companies building specific applications that use little of the overall technologies available in mobile devices, and does not allow for a completely synchronized and sequenced delivery of interactive metadata.

### SUMMARY OF THE INVENTION

The present invention solves the foregoing deficiencies by creating eco-system whereby consumers with handheld devices (such as mobile phones, pad, laptops or other) can interact with and have bi directional relationship with either a screen (TV, Kiosk, PC, Movie Theater Screen. Billboard, Window screen etc) and/or a combination of a screen and a proximity location system.

This invention creates a new relationship between the consumer/viewer that allows for complete synchronized and sequenced interactions between the mobile device and other screens, such as a kiosk, a billboard and any related signage, either video or static. Such interaction enables new methods for the following capabilities:
1. Synchronized sequenced interaction with a TV show, whether live or pre-recorded. The invention can identify either the location of the user/viewer and/or the audio emitted from the Screen. The audio does not require or rely on pre-embedded watermarking, ID information or time code.
2. Live events interaction with other screens, such as a kiosk, jumbotron, a billboard and any related signage, either video or static
3. Physical locations such as Retail, Transportation facilities and vessels. The consumer/viewer can interact with other screens such as a kiosk, a billboard and any related signage, either video or static at the location, either inside or outside.
4. The invention also enables the consumer/viewer to “bookmark” the experience, at any time during the viewing experience. The “bookmark, allows for the consumer/viewer to continue the interaction and or viewing of the primary content or the “meta data” at any time.
5. The Invention includes a system for advertisers and brands to interactively participate in delivering branded messaging/offers that includes features, but not limited to replenishable and refillable “buckets” that contain offers that can be stored and viewed, and redeemed, which acts as a tiling systems for easy access to such branded messaging/offers and the redemption of such branded messaging/offers.

The invention is directed to solutions that enable many technologies to coincide with one another creating a system that provides advertisers with a complete interactive offer system (coupons, special offers, “viral” promotional games, etc.) that provides delivery, storage and redemption of offers for handheld/mobile device users in an interactive manner. In the scenario where a consumer is watching a consumer/video, an audio fingerprinting technique is one method that the invention utilizes to determine relative positions in a video stream. Location based identification is used to serve content relative to a users location. Demographic, psychographic, and other ‘tagging’ is used to serve interactive offers that are relevant to the user. The overall system is designed to provide an advertiser with a range of tools to create an advertising/marketing eco-system that adds value to the consumer/viewer.

The invention provides a unique and complete solution to advertising and marketing that enables many different technologies that coincide with each other creating a full system providing advertisers and users with relevant, interactive offers, promotions, and advertisements. While also providing the delivery, storage and redemption of all offers for handheld/mobile device users in a manner that allows tracking their advertising & marketing campaigns effectiveness from start to finish.

In one embodiment, as an advertisement for a product is being broadcast/displayed on a television or other primary device, the user/audience visually sees the advertisement on the video screen. At that point in time, either via a synchronization with the broadcast or, in the case of a live broadcast, by virtue of the time at which the advertisement is being shown, on a second device, a discount or coupon or other incentive is pushed to the second device such that the user can view and/or interact with it on that device. In another embodiment, rather the being connected with an advertisement being viewed, the location of the user, as determined for example by a Global Positioning System (GPS) or mobile network location service on the second device, can be used to provide an offer or other incentive on the second device. The offering is relevant to the users particular location. In either case, rather than showing the actual discount or coupon or other incentive on the second device, the user can press a button on the second device, or use an accelerometer function of the device to signal that the user desires to “catch” discount or coupon or other incentive which is then displayed on the second device.

The response/request is acknowledged by the server which pushed the discount or coupon or other incentive. The user can then store the discount or coupon or other incentive in a bucket on the second device for use at a retail location which offers the product for sale. The user may also choose to share the offer with others via a variety of social-media technologies, email, etc. The specifics of how the coupon is redeemed will depend on the nature of the coupon, product and retail store, but such specifics are not important for an understanding of the invention. Likewise, there are many ways in which a user might share the offering with others.

In another embodiment, the invention provides a mechanism for those watching any form of video program to leave at any point in a program and access it at a later point without needing to remember where the program was stopped or paused. Furthermore, the invention does not rely on the user buy ing specialized equipment. In fact any device (mobile phone, handheld device, PC, etc.) equipped with a microphone or other audio input can be made capable of providing the user with the capability to return to a specific point in a video through the use of the invented system.

The user only needs to start a software application on the device—either at the beginning or at any point within a video program being watched. When the user want to leave the program, the user presses a button (a physical button or a “soft” button on a touch-enabled display, or another input-selector on the device (e.g. a shaking of the device might trigger the accelerometer) to create a “bookmark.”

### BRIEF DESCRIPTION OF THE DRAWINGS

FIG. 1 is a flow diagram showing an interactive coupon delivery system.

FIG. 2 is a flow diagram showing an interactive coupon delivery system using catch technology.

FIGS. 3a-3c are a flow diagram showing bookmarking and retrieving of video content.

FIG. 4.1 illustrates server and social media interaction.

FIG. 4.2 illustrates audio fingerprinting processing.

FIG. 4.3 illustrates coupons and a bucket database.

FIG. 4.4 illustrates synchronized screens processing.

FIG. 4.5 illustrates coupon verification.

### DETAILED DESCRIPTION OF THE INVENTION

In the following description, the following terms are utilized and should be understood to have the following meanings:

Second screen technology refers to the use of a primary screen for viewing of content that is non-interactive while also viewing interactive content on a second screen that is related to the content on the primary screen. Many variations on the primary screen exist including but not limited to telexisions, theater screens, electronic signage/billboards, and streaming/recorded video on personal computer screens. Many variations of second screens also exist. These include handheld/mobile devices such as smart-phones, handheld devices (e.g. iPod Touch), tablets (e.g. iPad, etc.), personal computers, and others. Related content does not mean that content on the primary screen appears in any form on the second screen, but rather, the content on the second screen takes into account the position in the video content being displayed on the primary screen relative to a starting point. Users view video content on the primary screen and interact with additional information (including menus, text, graphics, additional video, etc.) on a second screen that is related to the content on the primary screen.

The term offers is reflective of many types of different advertising/marketing promotions including coupons, vouchers, promotional giveaways, etc.

Interactive Mobile Coupon Offer, Delivery, Storage. Redemption System

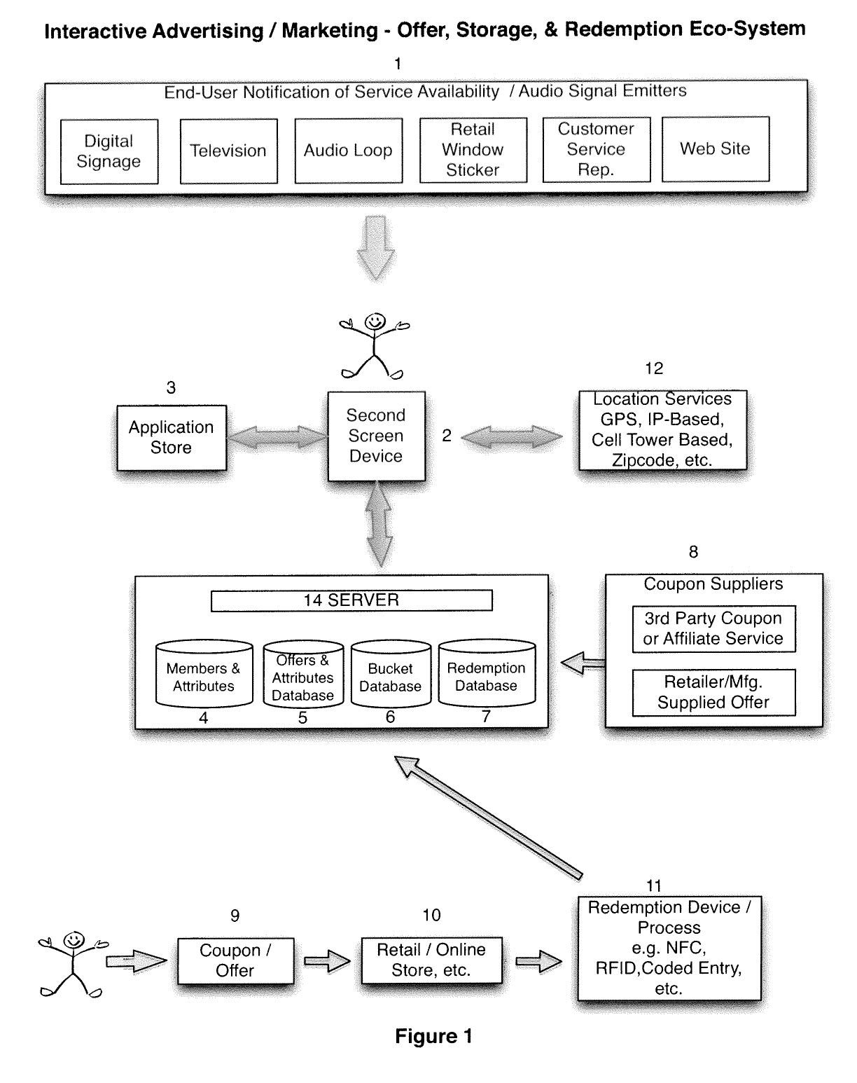

Referring to FIG. 1, a user (customer) is notified of a service through marketing efforts (a video commercial loop, an audio commercial loop, and/or a posted graphic/text notification, traditional web and/or social media websites, etc.) 1 of a service available to them which they can subscribe to by sending a text message and/or using a mobile device capable of installing a retailer's software application from a specific location (3) generally known as third party application stores. As shown in FIG. 1, a mobile device 2 such as a smart phone contacts an application server 14 over the Internet to download the application. Such download can be based upon direct contact with the server over the Internet, or, for example, by the user sending a SMS message to enroll, then receiving a link via SMS which is used to download the application. Once the application is installed, the user can register as a unique user with an enrollment server (for example, database 4) or gain access to the server as a guest (either the same server as unique users and/or one designated for guest users).

The user is provided with offers based on the physical/geographical location of the handheld device in their possession and their demographic, psychographic, or basic biographic data contained in the members & attributes database 4. Most currently available mobile devices have built in location mechanisms 12 using global positioning systems (GPS), their distance from Cellular/Mobile Data Towers, or via the IP address of their nearest access gateway which is used to provide the physical/geographical location of the device. Demographic, psychographic, or basic biographic data is data which the user has entered into the device or based on a stored usage history of the device. Such offers may originate from 1 a display video, audio or a static poster, etc.) or interaction with a customer representative. These offers are stored in an “offer bucket” (i.e., memory) on the device and/or on a server (database 6) designed to store these offers. Specific details on the offer (vendor/manufacturer, value, expiration, etc.) are contained in the offer database 5 for each offer and available for use by the customer. The offers come from 8 retailers, manufacturers, 3^{rd} party coupon porivers/affiliate programs, etc. The user can make use of the offer 9 at retail locations, online stores, and other partners 10 by a number of redemption technologies 11 such as embedded passive/active RFID (radio-frequency ID chip), NFC (near-field communications), and/or offer redemption services provided in-house or through third-parties (e.g., Coupons.com, Google Wallet, etc.)

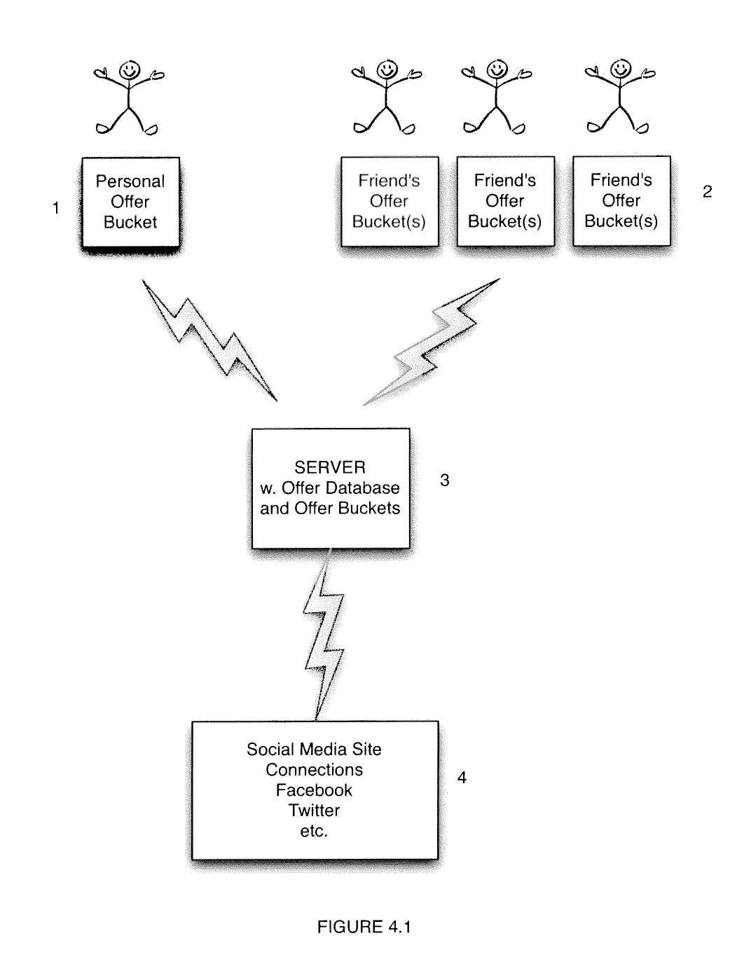

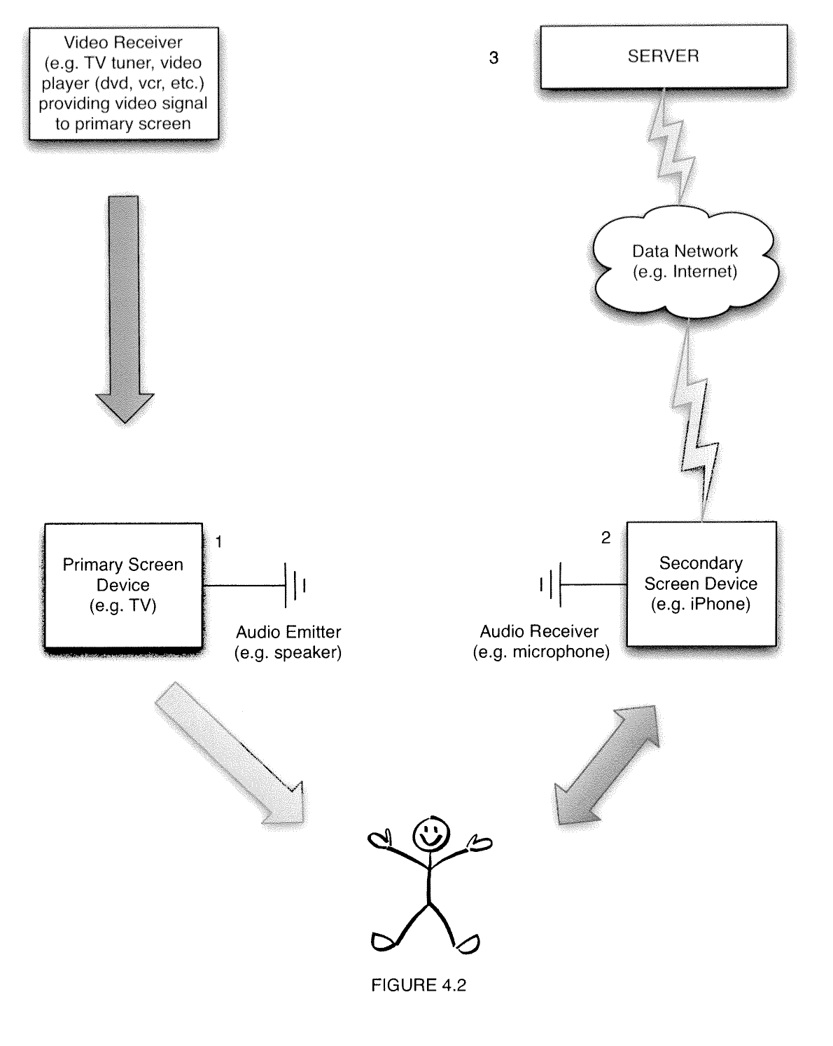

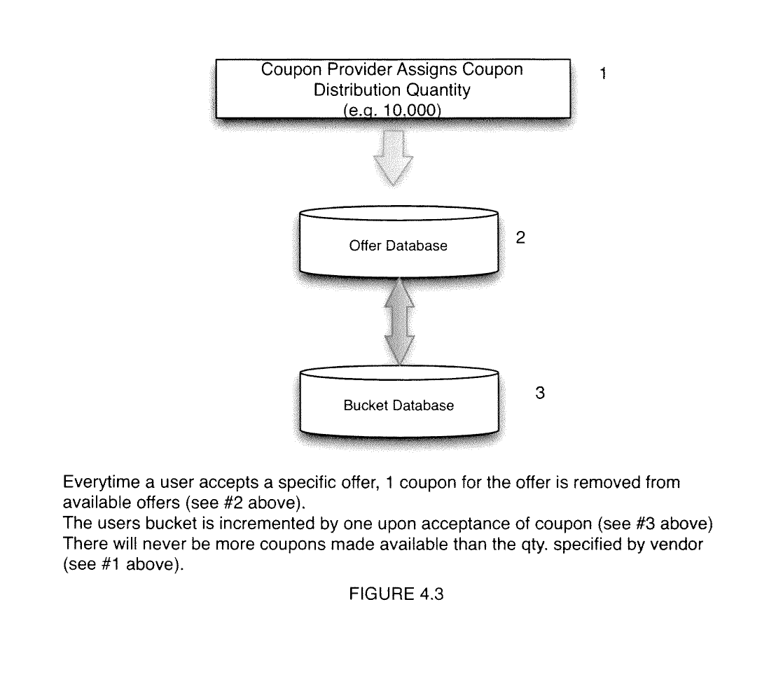

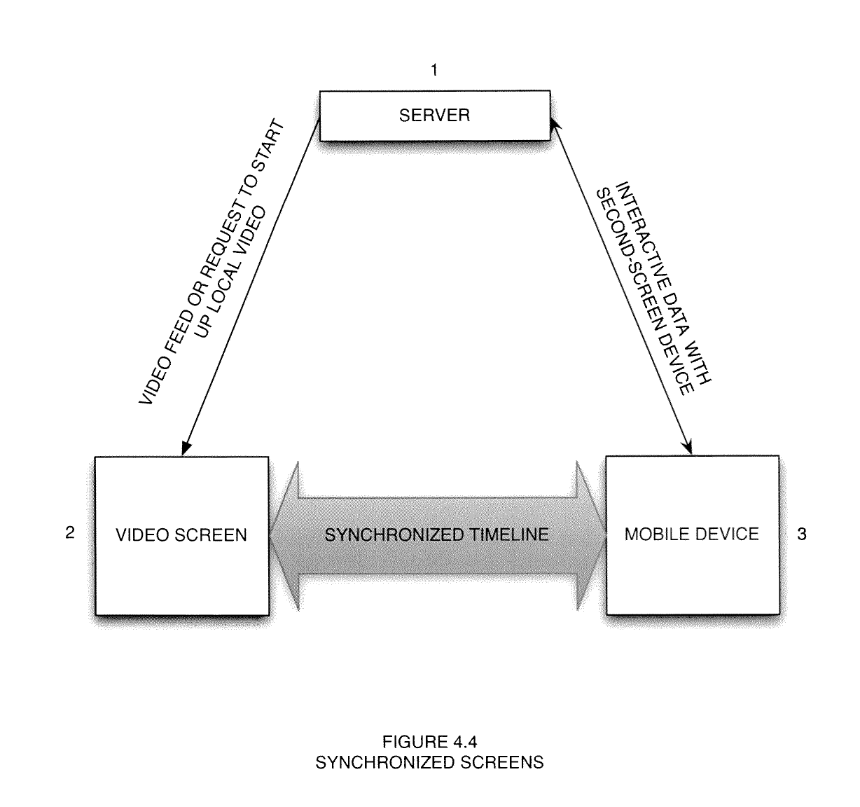

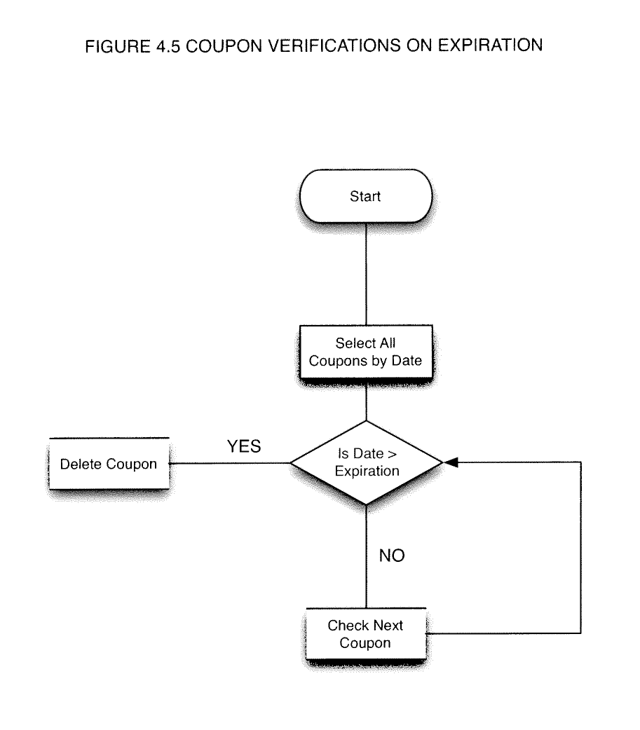

The technology can also be used socially (See FIG. 4.1) whereby a user collects offers received while watching the primary screen and interacting with content on the secondary screen. As described in FIG. 4-1, the user can then share the received offers in their personal offer bucket (1) with other users (2) and/or recommend to others they know by sending a link to the same offer as noted below. Offers are transferred on the server (3) from one bucket to another. In one embodiment this would allow those that may not have an interest in one particular offer to share it with someone they believe may be interested in it. Sharing can be done using any of the current or future social-media sites (4) (e.g. Facebook, Twitter, etc.) and/or through the application developers own sharing service (user to user sharing). Alternatively, the user could also enter or select the e-mail address or phone number of another person and share the offer—using the software application, via e-mail or SMS. Furthermore users of the application can rate offers based on the value they perceive them to have.

In a retail setting, a user can be provided with “Personal Shopping Concierge Services” whereby their device can provide a variety of services specific to the location they are visiting. This type of service is similar in nature to the individual user having a personal customer service assistant available for their use. The service can provide guided tours, store information and a variety of additional services to the user. These services may include promotions and special offers on specific products, brands, departments, etc. based on the user's location within the facility or based on their personal preferences. Present technologies provide for location based tracking of mobile devices equipped with location reporting of the latitude/longitude location of a particular device within 3 feet. This precision allows for a device to be provided with different advertising based on their actual movement within a retailer/service providers store/location.

In a further embodiment, the user is provided notification of competitive offers and/or services when a user of the application is located in a competitor location of one of the application providers partners.

Offer buckets contain offers that the user has collected. These offers are redeemed by users at various points 10. Limited time offers may expire and disappear. The bucket that contains the offers can be refilled based on different needs of advertisers/partners (Buckets and Refills Figure). As one example, a bucket that is empty of a particular partner's offers would signal the system to offer additional offers from that partner. In another example, a user that had a specific demographic, psychographic, or geographic location “tags” in their profile, but had a depleted number of offers matching those specific tags might be provided with additional offers that are a match.

As shown in FIG. 4.4 an additional embodiment of the invention also allows and enables video synchronization in a unique method by enabling a server (1) connected to the Internet to push video to a video enabled screen (2) and simultaneously interact and provide data to a mobile CPU (3) (such as a mobile phone, a pad, and any other mobile device). This allows for synchronized and sequenced interactivity between the consumer/viewer and the content that is appearing on the video screen.

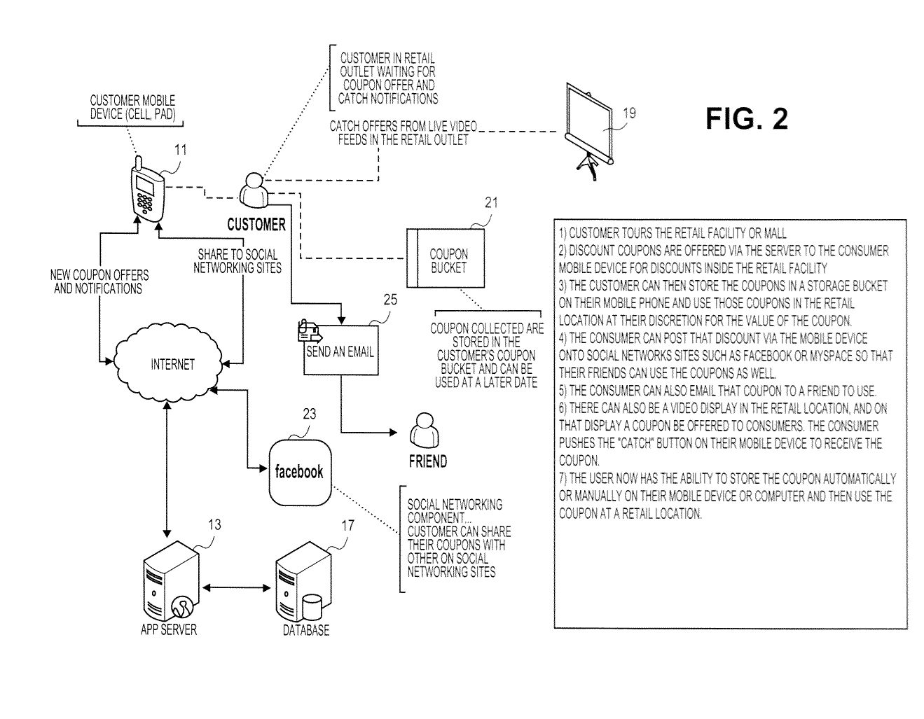

With reference to FIG. 2, interactive offers sent via the server to the client application of a user based on their geographic location or at random can be made more interactive through the use of what is referred to as Catch technology. Offerings are displayed via the application at various points which are displayed as text, graphical, and or animated offerings. In one embodiment, the primary screen 19 displays a person throwing an offer (coupon, etc.) towards the end user. The user can “catch” the offer by moving the handheld device 11 or pressing a button (soft touch-screen button or a physical button). A movement related event could be as simple as shaking the phone or waving it as if they were physically catching the animated offer thrown at them. This aspect of the technology makes use of an integrated accelerometer that is a part of many common handheld devices (phones, etc.). Upon catching the offer, it is disclosed to the user what the actual offer is (e.g., you've caught a coupon worth twenty-cents off a beverage). The user can then choose to accept the offer placing it in their bucket 21, accept and share it with someone else using a social network interface 23 such as Facebook or email 25, or pass/decline the offer. Furthermore the display can be visually enhanced using augmented reality technologies such as those that allow for a user to view the device's camera video display while overlaying graphics that appear as offerings on top of what the lens is seeing. In addition to primary screen displays showing video, the same system can be used with store-front window displays, on public transit ads, etc. using a variety of methods to locate and view the offer (entry of a unique ID, scanning a “QR Code” (A more recent image code that contains information), bar code, or other identifying mark). This technology can also make full use of the disclosed integrated audio-fingerprinting technologies (described below) which allow for the identification of a primary screen program and the location within that program.

The specifics for implementing Catch technology are not set forth herein since pressing a button to initiate an action or using a device's accelerometer to initiate an action as described herein are well within the skills of a person having ordinary skill in the field of the invention. The catch technology allows a form of entertainment to be had in receiving offers. Users of catch do not know ahead of time what type of offer they will receive and only know that it will either (a) be random, or (b) be within a category that they have selected. All offers sent to them will be based on their previously set preferences.

### Real-Time Interaction With Video Content

Although there are a variety of technologies that enable viewers of video content (television, PC videos, DVD's, etc.) to provide feedback (e.g. SMS messages, web sites for discussions, etc.), none of these provide true real-time interaction between the user and the video content they are watching. Those that do offer some form of interaction with a program via delivery of supplemental information to a device (a personal computer, mobile phone, handheld device, or other “second screen”, etc.) rely on special preparation of the content (e.g. information added to the media (audio and/or video) at the time of recording, during post-production or during broadcast). In some cases they may require the user to actually enter in the program that they are watching and a specific time-code.

The present invention provides a method and apparatus for real-time interaction between content viewers and users. In one embodiment of the invention, a technology known as audio fingerprinting is used to locate the content and provide time synchronization within the content. As shown in FIG. 4.2 audio fingerprinting takes a sample of audio from a primary device (1) using a microphone/audio-input associated with the second device (2). The analog signal is converted to a digital signal for further processing as an audio fingerprint. That fingerprint is then compared against known content for which interaction is available. In one embodiment, the fingerprint is sent to a server (3) on the internet for comparison against an existing digital audio pattern to find the location within the content. That is, the local audio being emitted from a local audio/video source (television, radio, theatre screen, etc.) is matched with a stored copy of the audio portion of the source. If a match is found, content from a remote server is sent to a second screen, which is, in a manner of speaking, synchronized with the content on the local audio/video source. By way of example, if a thirty-minute television program is being watched, its audio is sampled by a microphone local to the television at a particular point in time to create a fingerprint of the audio at that time. Typically, only a few second of audio is needed for a match. The entire audio portion which is prerecorded is stored in a format which can be efficiently matched with the created fingerprint of the audio and accessible over the Internet. In some cases, the prerecorded audio stored in a format which can be efficiently matched with the created fingerprint can be stored on the second device or another device on the local network. The fingerprint is then compared with the entire audio portion until a match is found. Assuming a match is found, the point in time which corresponds to the program being played on the television is determined thus, in effect, enabling anything desired to be displayed on the second device to be synchronized with the programming on the first/primary device. Fingerprints can be stored locally on the user's device or placed on a server attached to a data-network (e.g. a web server) for analysis. Unlike watermarking, at no point is the source media altered in any way and the user does not need to enter any information related to the program being played. Techniques for matching relatively small portions of an audio signal with large quantities of previously recorded audio are generally known in the art. One suitable system is a version of lunatic available from Sylvain Demongeot modified to provide the relative time or times of the match. The modified version is also available from Sylvain Demongeot. There may be times when the same fingerprint exists multiple times in the previously recorded audio. In this case, the first time the fingerprint appears is returned. Alternatively, all matched times can be returned and further processing performed to determine the correct one, if possible. Other indicia may be necessary to determine the correct relative time if the first occurrence is not correct. The specifics of the other indicia would depend upon the nature of the content, time of day and/or other factors.

By using an audio fingerprint, the present invention is able to detect whether there is corresponding interactive content created for use with any source of primary screen video.

The present invention provides several interactive modules designed to correspond with pre-recorded and/or live events (e.g. any video content, a special live performance, concert, news, scripted TV series, reality TV programs, etc). The content can be developed independently and/or in co-collaboration with providers of the content. However, at no time is any alteration of the primary screen content required and users of the technology are not required to manually enter program/time information. The system as a whole contains several modules which are developed into applications designed to be used on mobile/handheld devices known as “second screens”. The system includes both the user application and a content management system designed to allow producers, creators and interactive-television designers the ability to build content that can interact with the application.

Content modules may include, but are not limited to:
Coupon/Offers (offers for discounts, special products/service offerings, etc.).
Interactive Polls—Multi-choice polls related to content on a program or advertisement displayed during a program.
Single and Multi User Quizzes/Trivia—Mutiple choice and entry-text questions & answers.
Surveys—Surveys based on the program being watched or a product survey.
Social-Media—Interaction between users via comments, chat, etc.
Sweepstakes—Contests offering prizes and/or other special incentives for users to register to win.
Newsfeeds—Current information related to the video/event program or additional in-depth newsworthy content.
Interactive Brochures
Embedded Games
Story Books
Additional Video Content/Soundtracks, etc.
Closed Caption Content.

Implementation of these or other similar modules are well within the abilities of those having ordinary skill in the art.

A server application provides tracking and reporting on actual usage of the application on the second screen device and user interaction with any of the interactive modules included in the application. This data can be used for actual reporting purposes or for other purposes such as social interaction between users. In a situation such as a quiz or game, users may be competing solo against the clock, against their friends or against the rest of the interactive users participating. Incentives (points, special offers, etc.) can be awarded based on a user interacting with the content on the primary screen in real-time or after initial airing/broadcast, etc. and/or for interaction with other users. Point systems can vary (points for every correct answer, a reduced number of points for answering with a wrong answer, negative points for a wrong answer, etc.) to assist in engaging users of the application to participate. Points can be used in a similar manner to traditional loyalty programs (e.g. frequent flyer miles, etc.) for redemption of special offers (e.g. giveaways, sweepstakes, etc.). This can be integrated with 3^{rd} party loyalty programs.

Based on certain events taking place on the primary screen (e.g., a commercial for toothpaste) the system can bring up offers for related products (e.g. a coupon, special offer, etc.) that can be redeemed. Interactive news or enhanced content can be delivered with respect to the ongoing video or presentation on the primary screen. Consumers can store offers for later use in a digital filing system (“Offer Bucket”, “Coupon Clipping”, etc.). If an offer is used and/or expires, the bucket can be refilled.

Redemption of offers can be done via several well known technologies (RF-ID, Near Field Communications (NFC), third-party providers, etc.) The invention can take the user all the way from an on-screen advertisement (on the primary screen), driving them via an offer to a service provider (e.g. a retail store) and track there redemption and/or adoption. The invention also provides a significant improvement on the ability to identify where content was seen, when it was seen, and the time between viewing and the actual redemption/adoption of services and/or products.

### Audio Fingerprinting to “Bookmark” A Location Within a Video

When first introduced, Personal Video Recorder (PVR) and Digital Video Recorder (DVR) technologies allowed users to record video while they were watching it on their television. These systems enabled users of these special devices to leave the room while watching programs and return at a later point in time and rewind to the moment they remembered leaving the program. It also allowed them to revisit/replay content at any point in a program.

Several issues come up with such a technology:
Users need to purchase a specialized device or purchase a video receiver that has the PVR technology integrated within it. This can be costly and in the case of integrated units, the unit is often only compatible with certain cable and/or satellite providers requiring the user to replace it when changing providers.
Although a user can leave the room and return to a specific portion of the program by using the pause feature, any prolonged absence where another user may be using the unit will result in losing the paused position. If the program material is recorded, the user can of course rewind to the point in time where the user left the or otherwise stopped watching the content. However, the user must rewind through the media and search for the spot where the user stopped watching. In such a case it is up to the user to remember where the user left off and visually recognize that point while rewinding the video at a fast rate.
Although the prior art works for video received by various on-air/cable/satellite broadcasters, it does not take into consideration other types of programming that are available such as DVD, Internet/Web video, etc.

A video bookmarking application is installed on a second screen device which enables a user to register an account with a server that will be used for the purpose of identifying the user when a bookmark is to be created.

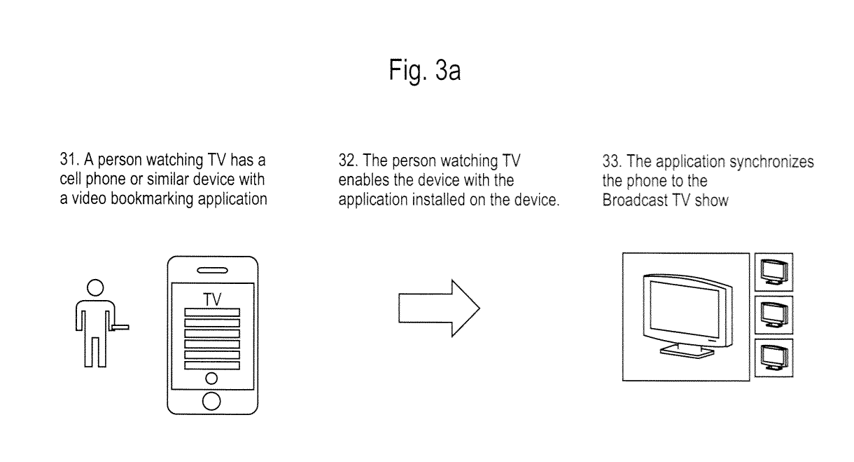

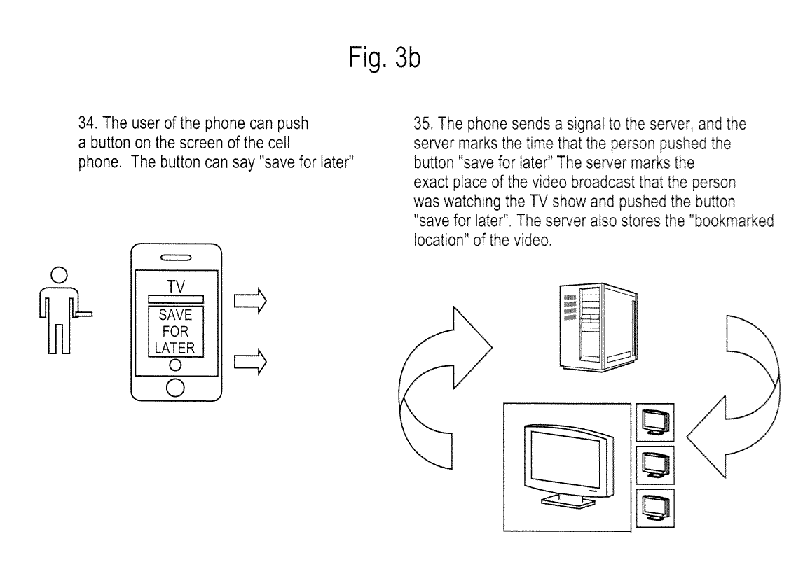

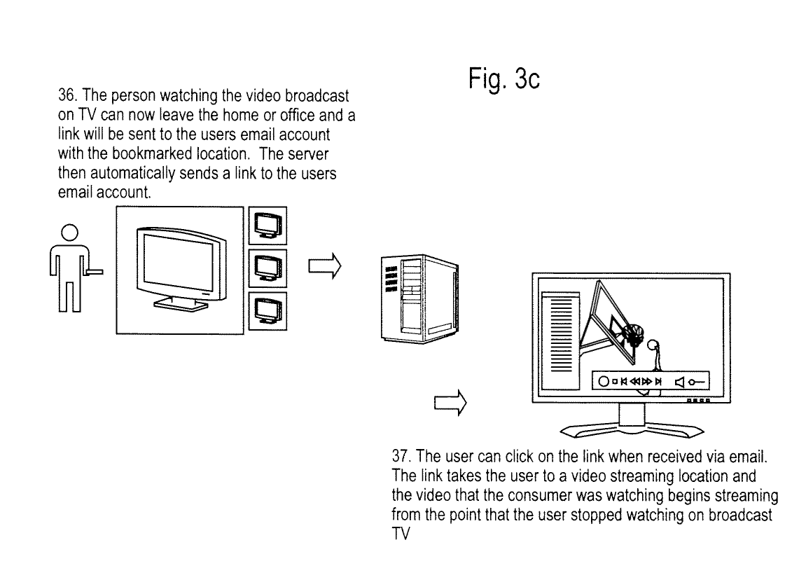

In use, with reference to FIGS. 3a-3c, while watching 31 a video on the primary screen, the user activates the video bookmarking application on a chosen second screen device (PC, mobile phone/handheld device 32, etc.). At that point the application begins sampling audio periodically to enable synchronization 33. The audio samples are stored locally on the device running the application. To “bookmark” (mark a point in the video) where the user desires to save the location in the video program, the user presses a designated button 34 (physical or “soft” button, etc.). This initiates a process in which the device looks back into its recorded audio file of periodically sampled audio and selects a section of audio beginning several seconds from the point at which the user pressed the bookmark button. This audio sample is packaged as a file or stream which is sent to a server 35. The file is labeled with a default name and/or additional user entered identification information (e.g. My Favorite Show, etc.) At this time 36, the user may leave the leave the home office or other location where the video was being watched.

Furthermore the user may also be provided with the ability to select a section of the video which is at a point-in-time prior to pressing the bookmark button (e.g. 60 seconds prior, 30 seconds prior, etc.) Users of the sharing feature can share specific scenes which make up a better part of the “viral video” market of short-clips discovered during the viewing of regular programs. PVR/DVR and other similar prior art technologies do not offer any form of link e-mailing/sharing.

The audio samples fingerprint is sent to a remote server designed to receive store them under the identity of the user. The server may also record additional information such as the time/date of the recording and/or other identifying information to aid the user in identifying the video. The server may also assist the user by sending an e-mail message, SMS message, or notifying the user of the received fingerprint and its “bookmark” via other methods. Furthermore the application on the second device may store the bookmark so that the user can access it directly from the device, share it with others, etc.

A server application designed to scan through the audio portion of available videos (received from networks, producers, through Internet video providers, etc.) and locate a match between the fingerprint and a specific point in any of the available video. This allows the user to return to the same point in a video that they left off. In an alternative embodiment, a full analysis of the video can be completed and the “extended fingerprint” stored on the user's device. The sampled fingerprint can then be matched locally on the user device without the need to send the fingerprint to the server for analysis.

A server application is adapted to store video bookmarks and associate them with a particular user and a time within a particular video. This may be further enhanced by providing the user with the ability to share their bookmarks providing others with the ability to see a particular scene/section of video. Users can return by selecting the link 37 sent to them in email and/or by selecting one of the bookmarks available on a website under their user ID, and/or by selecting a link in the mobile application. Upon selecting the bookmark, access to the video is obtained by linking to a stored copy on an accessible data network (e.g. a web site on the Internet designed to provide access to pre-recorded videos by users, a video producer or television network video library, etc.). The user is presented with the video and it is cued up to the point in time Where they chose to associate the bookmark.

The specifics of the techniques utilized to implement the specified functionality on second device and server applications is known to persons skilled in the art, and, therefore, are not detailed herein. Although audio fingerprinting, searching, matching audio portions and the like needed to implement the described functionality is well known, the present invention is directed to novel uses of these techniques as described and claimed herein.

1. Method for providing real-time interaction with broadcasted audio/video content comprising:
a) sampling via a microphone an audio segment from a broadcasted audio/video content received on an audio/video device;
b) converting the sampled audio segment to a digital signal;
c) comparing the digital signal with a digital snapshot of an audio pattern that co responds to the audio portion of the broadcasted audio/video content;
d) determining a current position relative to a beginning of said broadcasted audio/video content based on said comparing;
e) displaying on a second audio/video device an interactive display based on said determined current position.

2. Method for providing an interactive coupon/offer delivery via a mobile device comprising:
a) receiving a request from a mobile device to establish a location of the mobile device;
a) determining the location of the mobile device;
b) sending an offer to the mobile device based on the determined location;
c) receiving confirmation from said mobile device that the offer has been received;
d) processing the offer based on a request received from the mobile device, wherein said processing is at least one of redeeming and sharing the offer.

3. Method for providing an interactive coupon/offer delivery via a mobile device comprising:
a) receiving a request from a mobile device to receive an audio signal;
b) receiving the audio signal;
c) sampling the received audio signal and converting the sampled audio signal to a digital signal;
d) comparing the digital signal with a digital snapshot of an audio pattern that corresponds to the audio portion of broadcasted audio/video content;
e) determining a relative time of said broadcasted audio/video content based on said comparing;
f) sending an offer to the mobile device based on the determined relative time;
g) receiving confirmation from said mobile device that the offer has been received;
h) processing the offer based on a request received from the mobile device, wherein said processing is at least one of redeeming and sharing the offer.

4. Method for providing an interactive coupon/offer delivery via a mobile device comprising:
a) sending at least one of audio and video content to a receiving device;
b) sending interactive content to a mobile device located near said receiving device;
c) receiving a signal from said mobile device based on said sent interactive content;
f) sending an offer to the mobile device based on said received signal;
g) receiving confirmation from said mobile device that the offer has been received;
h) processing the offer based on a request received from the mobile device, wherein said processing is at least one of redeeming and sharing the offer.

5. Method for receiving an interactive coupon/offer via a mobile device comprising:
a) providing location information based on a location of a mobile device;
b) upon receiving notification that a coupon/offer is available, generating a signal to request delivery of said coupon/offer by said mobile device determining a movement of said device in a predetermined manner.

6. Method for bookmarking a point within a video stream comprising:
a) sampling via a microphone an audio segment from a broadcasted audio/video content received on an audio/video device;
b) converting the sampled audio segment to digital data;
c) receiving a signal to set a bookmark;
d) transmitting the digital data to a storage device with identifying information for said video stream.

7. Method for retrieving a stored video stream comprising:
a) receiving a request to retrieve a stored video content, said request including an audio fingerprint;
b) searching a database including the previously stored video streams to locate an audio fingerprint within the video stream which matches the audio fingerprint of the request;
c) determining a location within said stored video stream corresponding to said matched audio fingerprint;
d) streaming the video stream from said determined location.
